(19) United States
(12) Patent Application Publication
(10) Pub. No.: US 2016/0243387 A1
(43) Pub. Date: Aug. 25, 2016

(54) LONG-DISTANCE FLUID INJECTION DEVICE

(71) Applicant: Jang Woo LEE, Guri-si, Gyeonggi-do (KR)

(72) Inventor: JANG WOO LEE, GYEONGGI-DO (KR)

(21) Appl. No.: 15/033,268

(22) PCT Filed: Aug. 22, 2014
(86) PCT No.: PCT/KR2014/007824

§ 371 Date: Apr. 29, 2016

(30) Foreign Application Priority Data
Nov. 5, 2013 (KR) KR10-2013-0133444

(51) Int. Cl. A62C 31/05; B05B 1/18

(52) U.S. Cl. CPC A62C 31/05; B05B 1/185

(57) ABSTRACT

Disclosed is a long-distance fluid ejection device. A nozzle for long-distance fluid ejection according to an embodiment of the present invention comprises: a main body connected with a hose which flows fluid within the inner portion thereof; a nozzle which has a circular flat plate shape and includes a plurality of fluid spray holes, the further from the center of the nozzle the number of which relatively increases, and which is equipped at the front end of the main body; and a coupling unit for coupling the nozzle to the main body. The plurality of fluid spray holes each comprises: an opening; and a direction switching unit projected to the inside of the opening along the radial inward direction of the nozzle.

### TECHNICAL FIELD

The present invention relates to a long-distance fluid ejection device, and more particularly, to a long-distance fluid ejection device that is capable of ejecting the fluid farther away by joining of fluid ejected through a long-distance fluid ejection device.

### BACKGROUND ART

Nozzles for ejecting fluid distribution is installed in a terminal of a shower and a fire fighting nozzle and can adjust the direction, the flow rate, the flow velocity and the like of the fluid ejected through the nozzle for ejecting the fluid.

In general, in the fire fighting nozzle or the like that needs to eject the fluid farther away, a cross-sectional area of a flow passage is narrowed to increase the flow velocity of fluid and eject the fluid farther away. To this end, the conventional fire fighting nozzles mainly use a method of adjusting the ejection distance of the fluid, by varying the flow path cross-sectional area in accordance with the movement of a moving body provided in the interior of the nozzle.

However, there is a limit in increasing the ejection distance of the fluid by simply adjusting the cross-sectional area of the flow passage as in the conventional cases.

### DISCLOSURE

### Technical Problem

The present invention was made to solve the conventional problems described above, and an object of the present invention is as follows.

An embodiment of the present invention is to provide a long-distance fluid ejection device capable of ejecting fluid farther away.

The objects of the present invention are not limited to those mentioned above, and other objects that have not been mentioned will be clearly understood by those skilled in the art from the following description.

### Technical Solution

According to an aspect of the present invention, a long-distance fluid ejection device may include a main body, a nozzle and a coupling unit.

The main body may be connected to a hose through which fluid flow.

The nozzle has a circular flat plate shape, and is formed with a plurality of fluid ejection holes disposed in a relatively large number as they go away from the center, and may be provided in a leading end of the main body.

Each of the plurality of fluid ejection holes may include an opening, and a direction switching unit protruding to the inside of the opening in the radial direction of the nozzle.

The coupling unit may couple the nozzle to the main body.

A center hole from which fluid is discharged in a straight line may be formed at the center of the nozzle.

The direction switching unit may be formed toward the center of the nozzle from the outside of the radius of the nozzle.

The opening may have a main ejection region located at the center portion, and a pair of auxiliary ejection regions divided by the direction switching unit.

The fluid ejection holes may be disposed on a plurality of concentric circles formed based on the center of the nozzle.

The plurality of fluid ejection holes located on one concentric circle may be disposed so as to be spaced apart from each other at predetermined intervals.

Meanwhile, the plurality of concentric circles may be disposed so as to be spaced apart from each other at predetermined intervals.

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Advantageous Effects

The effects of the present invention configured as described above are as follows.

According to the long-distance fluid ejection device according to an embodiment of the present invention, the fluid ejected through the fluid ejection hole is ejected obliquely toward the center axis to form a single stem in the center axis. Accordingly, it is possible to eject the fluid farther away.

Effects of the present invention are not limited to the aforementioned effects, and other effects that have not been mentioned will be clearly understood to those skilled in the art from the scope of the claims.

### BRIEF DESCRIPTION OF THE DRAWINGS

The summary described above as well as the detailed description of the preferred embodiments of the present application which will be described below will be more clearly understand when read in conjunction with the accompanying drawings. The preferred embodiments are illustrated in the drawings for the purposes for illustrating the present invention. However, it should be understood that the present application is not limited to the illustrated accurate arrangements and means.

FIG. 1 is a diagram illustrating a fire fighting nozzle to which a long-distance fluid ejection device according to an embodiment of the present invention is applied.

FIG. 2 is a diagram illustrating a nozzle of a long-distance fluid ejection device according to an embodiment of the present invention.

FIG. 3 is an enlarged view of a fluid ejection hole formed in the nozzle of the long-distance fluid ejection device according to an embodiment of the present invention.

FIG. 4 is a diagram illustrating the cross-section of the nozzle of the long-distance fluid ejection device according to an embodiment of the present invention and the flow of fluid.

FIG. 5 is a photograph illustrating a state in which fluid is ejected by the fire fighting nozzle to which the conventional fluid ejection device is applied.

FIG. 6 is a photograph illustrating a state in which fluid is ejected by the fire fighting nozzle to which the long-distance fluid ejection device according to an embodiment of the present invention is applied.

FIG. 7 is a diagram illustrating a nozzle of a long-distance fluid ejection device according to another embodiment of the present invention.

FIG. 8 is a diagram illustrating a nozzle of a long-distance fluid ejection device according to still another embodiment of the present invention.

### BEST MODE FOR THE INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, an embodiment of the present invention will be described in detail with reference to the accompanying drawings. However, the attached drawings are only described to more readily illustrate the contents of the present invention, and a person having ordinary skill in the art will be able to easily understand that the scope of the present invention is not limited to the scope of the attached drawings.

Further, in describing the embodiments of the present invention, it should be understood that components having the same function are only denoted by the same names and the same reference numerals, and are not substantially exactly the same as the components of the prior art.

Furthermore, terms used in this application are simply used to describe particular embodiments and are not intended to limit the present invention. The singular representation includes a plural representation, unless otherwise indicated in a clearly different manner on the context. In this application, it should be understood that terms such as “comprises” or “has” are used to specify the presence of features, numbers, steps, operations, elements, parts or a combination thereof described in the specification, rather than excluding possibility of presence or addition of one or more other features, numbers, steps, operations, elements, parts or a combination thereof in advance.

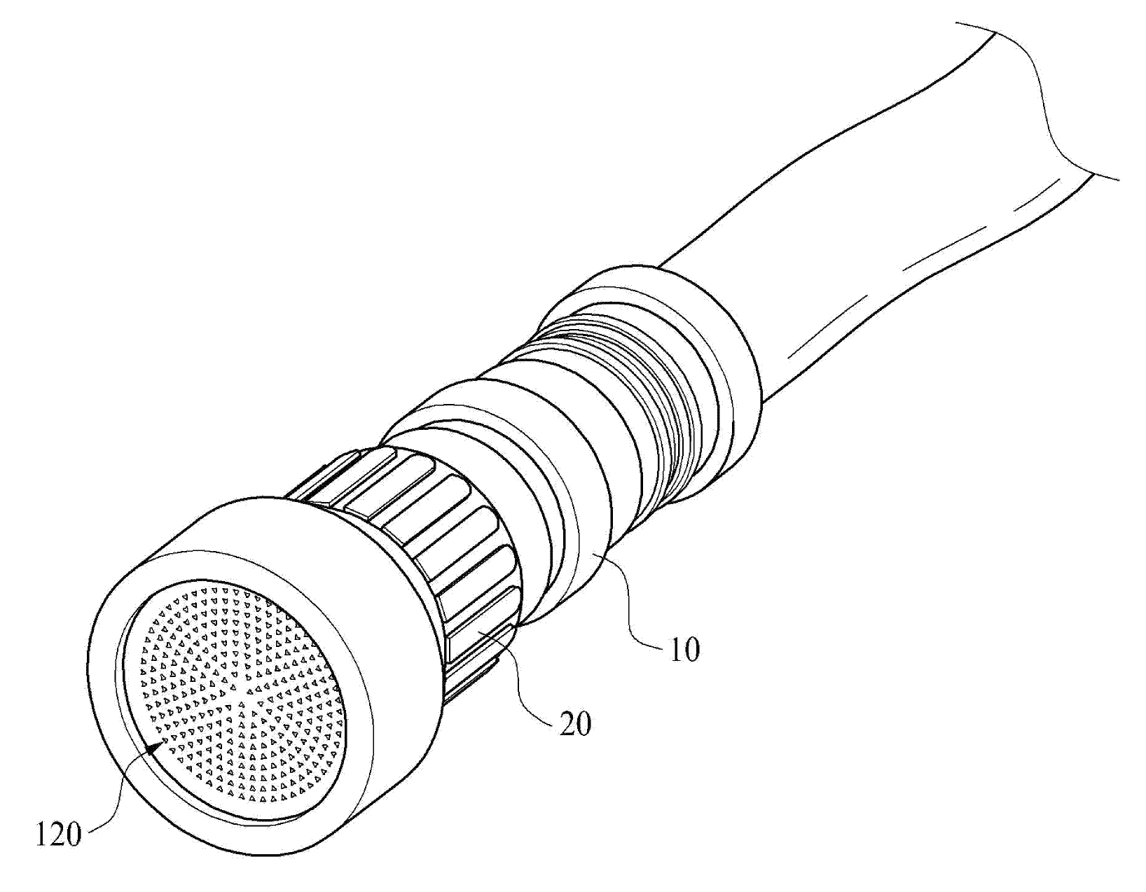

FIG. 1 is a diagram illustrating a fire fighting nozzle to which a long-distance fluid ejection device according to an embodiment of the present invention is applied.

Hereinafter, the long-distance fluid ejection device according to an embodiment of the present invention will be described with reference to FIG. 1.

The long-distance fluid ejection device according to an embodiment of the present invention includes a main body 10, a nozzle and a coupling unit 20.

The main body 10 may be connected to a hose through which fluid flows.

The nozzle 100 may be made of a metal material and may have a predetermined thickness in a circular flat plate shape.

A reference point 110 may be any point on the nozzle 100. In this embodiment, the nozzle 100 is formed in a circular shape, and the reference point 110 may be located in the center of the nozzle 100.

A plurality of fluid ejection holes 120 is formed in the nozzle 100, and the number of fluid ejection holes 120 may relatively increase as it goes away from the reference point 110.

Further, the nozzle 100 may be coupled to the main body 10 by the coupling unit 20.

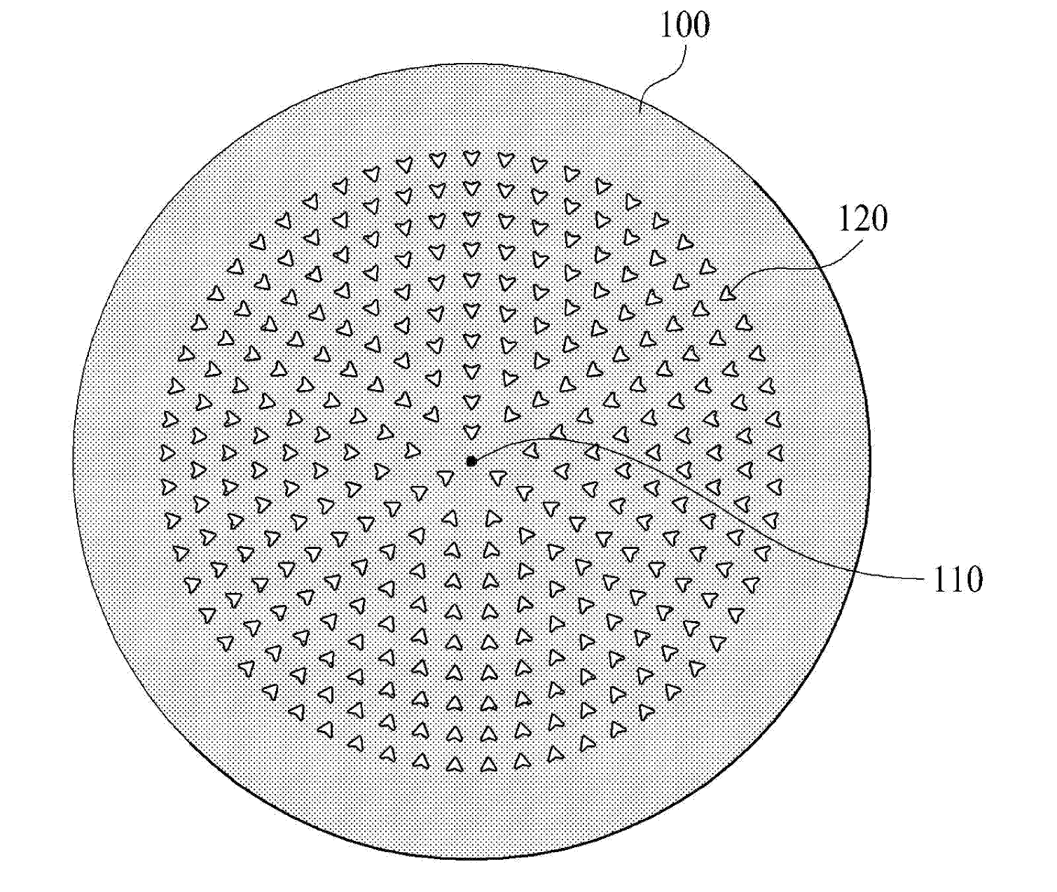

FIG. 2 is a diagram illustrating the nozzle of the long-distance fluid ejection device according to an embodiment of the present invention.

In the present embodiment, a plurality of fluid ejection holes 120 may be disposed on each of a plurality of concentric circles centered around the reference point 110. The fluid ejection hole 120 may include an opening 122, and a direction switching unit 124 that protrudes to the inside of the opening 122 toward the reference point 110. The detailed shape of the fluid body ejection holes 120 will be described later.

Accordingly, the fluid ejected through the fluid ejection hole 120 is obliquely ejected toward the center axis of the nozzle 100 and can be joined at the center axis.

Although FIG. 2 illustrates an example in which the respective concentric circles are spaced apart from each other by a predetermined distance, the spaced distance of each concentric circle does not need not be always constant.

Further, the drawings illustrate an example in which a plurality of fluid ejection holes 120 located on a single concentric circle are arranged to be spaced apart from each other at a predetermined interval, all the spaced distances between the plurality of fluid ejection holes 120 located on the single concentric single may also be differently disposed.

Also, although the drawings illustrate an example in which the fluid ejection holes 120 located on each concentric circle are located on a straight line in the radial direction of the nozzle 100, the invention it is not limited thereto, and as long as the fluid ejection holes 120 are located on a concentric circle centered on the reference point 110, they may be irregularly arranged in the radial direction of the nozzle 100.

Meanwhile, although it is not illustrated in the drawings, the nozzle 100 according to an embodiment of the present invention may further include a center hole that is formed on the reference point 110 so that the fluid is ejected in the direction coincident with the center axis.

The shape of the center hole may have a circular form or a regular polygon such a triangular shape and a square shape so that redirection of the fluid ejected through the center hole does not occur.

The flow velocity of fluid ejected through the nozzle 100 can become faster, while passing through the fluid ejection hole 120 and the center hole of the nozzle 100. According to Bernoulli's theorem, since the cross-sectional area of the flow passage becomes rapidly narrower at the fluid ejection hole 120 and the center hole on the pathway through which the fluid moves, the flow velocity of the fluid can increase.

Also, fluid ejected toward the center axis through the respective fluid ejection holes 120 is joined with the fluid ejected from the center hole, the flow rate becomes larger than a case of being ejected from each fluid ejection hole 120 or the center hole, the flow velocity becomes faster accordingly, and the fluid can be ejected farther away.

With the above-described effects of the long-distance fluid ejection device according to the present embodiment, although the long-distance fluid ejection device of this embodiment can also be used for a shower, a washing machine and the like, in particular, it can maximize the effect when being applied to the fighting nozzle of the fire hose.

At the time of fire suppression, it is required to eject a lot of flow farther away. When applying the long-distance fluid ejection device of the present embodiment to the fighting nozzle of the fire hose, the fluid can be ejected to farther away even at the same flow rate, and thus, it is very effective in fire suppression.

Also, since the long-distance fluid ejection device of this embodiment is formed in a flat plate shape, a complicated configuration for coupling is not required. When the device is simply inserted into a stepped portion in the fire fighting nozzle, since the device is pressurized by water pressure and is supported on the stepped portion of the distal end of the fire fighting nozzle, by simply replacing the conventional nozzle or the like with the long-distance fluid ejection device of the present embodiment, the aforementioned effects can be expected.

However, in order to apply the long-distance fluid ejection nozzle of this embodiment to the fighting nozzle of fire hose, it can have a sufficient thickness and rigidity enough not to be deformed or detached even at the very strong water pressure.

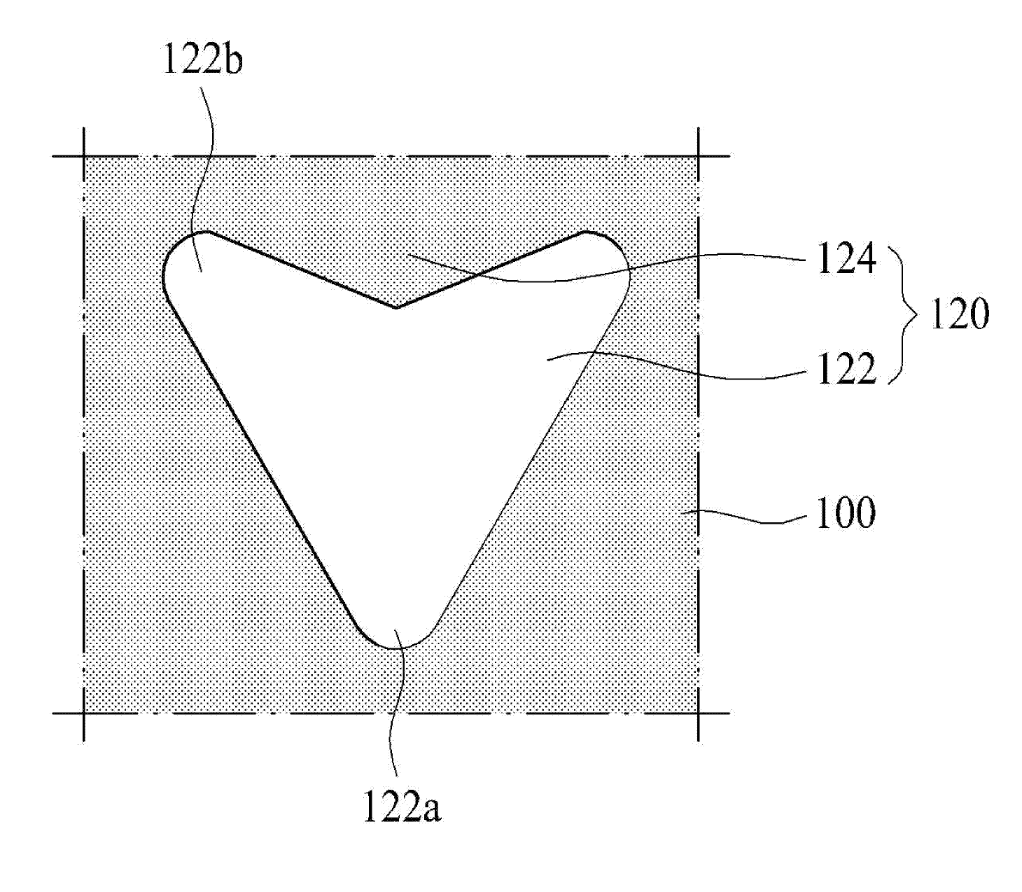

FIG. 3 is an enlarged view of the fluid ejection hole of the nozzle according to an embodiment of the present invention.

Although the shape of the fluid ejection hole 120 may be variously formed, as illustrated in FIG. 3, the shape of the fluid ejection hole 120 of the nozzle 100 according to an embodiment of the present invention illustrates a heart shape.

The shape of the fluid ejection hole 120 of the present embodiment will be described in more detail. The direction switching unit 124 projects toward the reference point 110 to the inner side of the opening 122, and the opening 122 may have a circular arrow shape or heart shape in which its width increasingly decreases as it goes toward the reference point 110.

That is, the opening 122 can have a main ejection region 122 located at the center portion, and a pair of auxiliary ejection regions 122b divided by the direction switching unit 124.

The flow rate of the fluid discharged through the fluid ejection hole 120 is concentrated to the main ejection region 122a by the direction switching unit 124, the direction of the discharged fluid can be changed accordingly.

In particular, as a result of the test, when the fluid ejection hole 120 has a circular arrow shape or heart shape, the degree to which water is obliquely ejected, stability of the structure and ease of manufacturing were the most excellent.

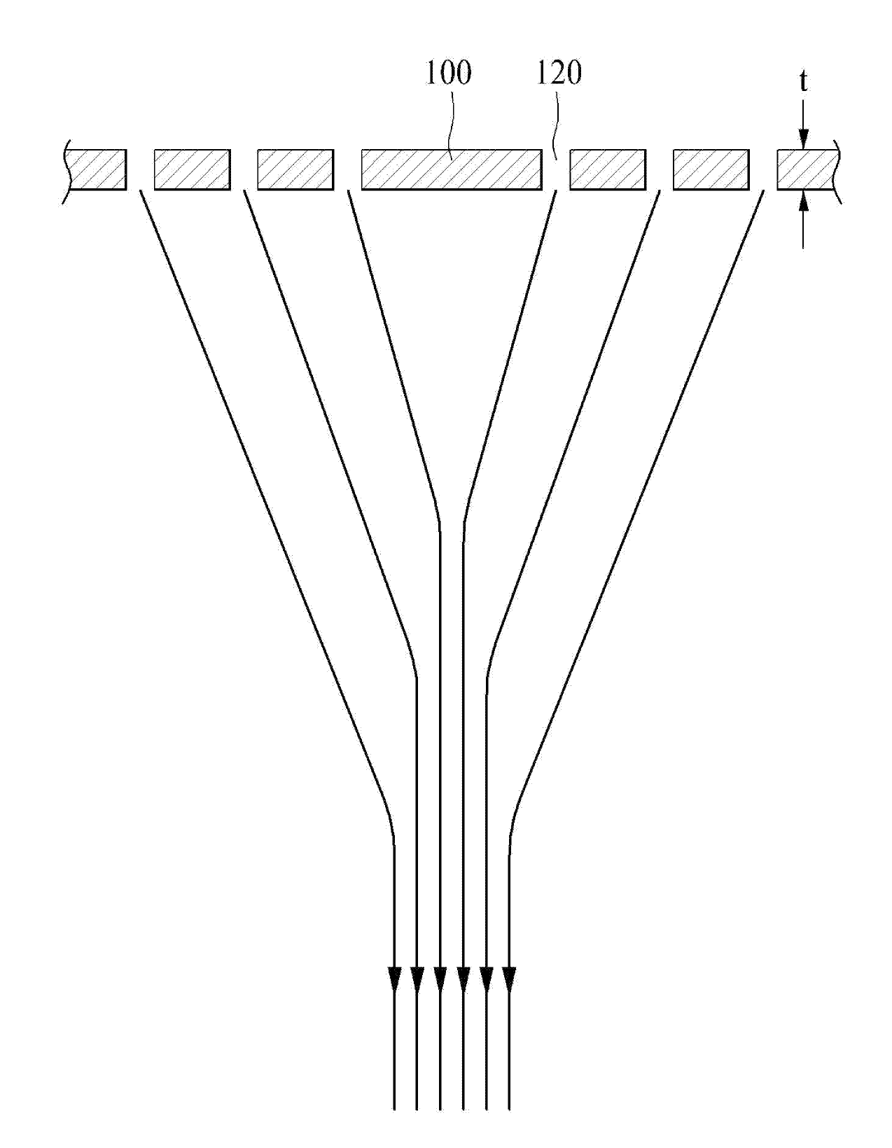

FIG. 4 is a diagram illustrating the cross-section of the nozzle according to an embodiment of the present invention and the flow of fluid.

As in the present example, when the fluid ejection hole 120 is formed in the arrow shape or heart shape the width of the opening 122 is narrowed as it goes toward the reference point 110, a phenomenon in which the flow rate is concentrated on the main ejection region 122a can be further be enhanced.

Each fluid ejection hole 120 is formed in a circular arrow shape or heart shape toward the reference point 110, and the direction switching units 124 provided in the respective fluid ejection holes 120 are inserted into the opening 122 toward the reference point 110. Accordingly, as illustrated in FIG. 4, the whole fluid ejected through the respective fluid ejection holes 120 can be directed to the center axis of the nozzle 100. Accordingly, the fluid ejected through the respective fluid ejection holes 120 can be joined at the center axis. Since large water flow formed by joining of each water flow increases in the flow rate as compared to each water flow, the flow velocity increases accordingly. Thus, the flow velocity of the fluid increases once due to the reduction of flow passage cross-sectional area, while passing through the nozzle 100, and when each water flow is joined at the center axis by the direction switching unit 124, the flow velocity is consistent from its flow velocity further increases. Therefore, fluid can be ejected farther away as compared to a case of increasing the flow velocity by simply reducing the cross-sectional area of the flow passage.

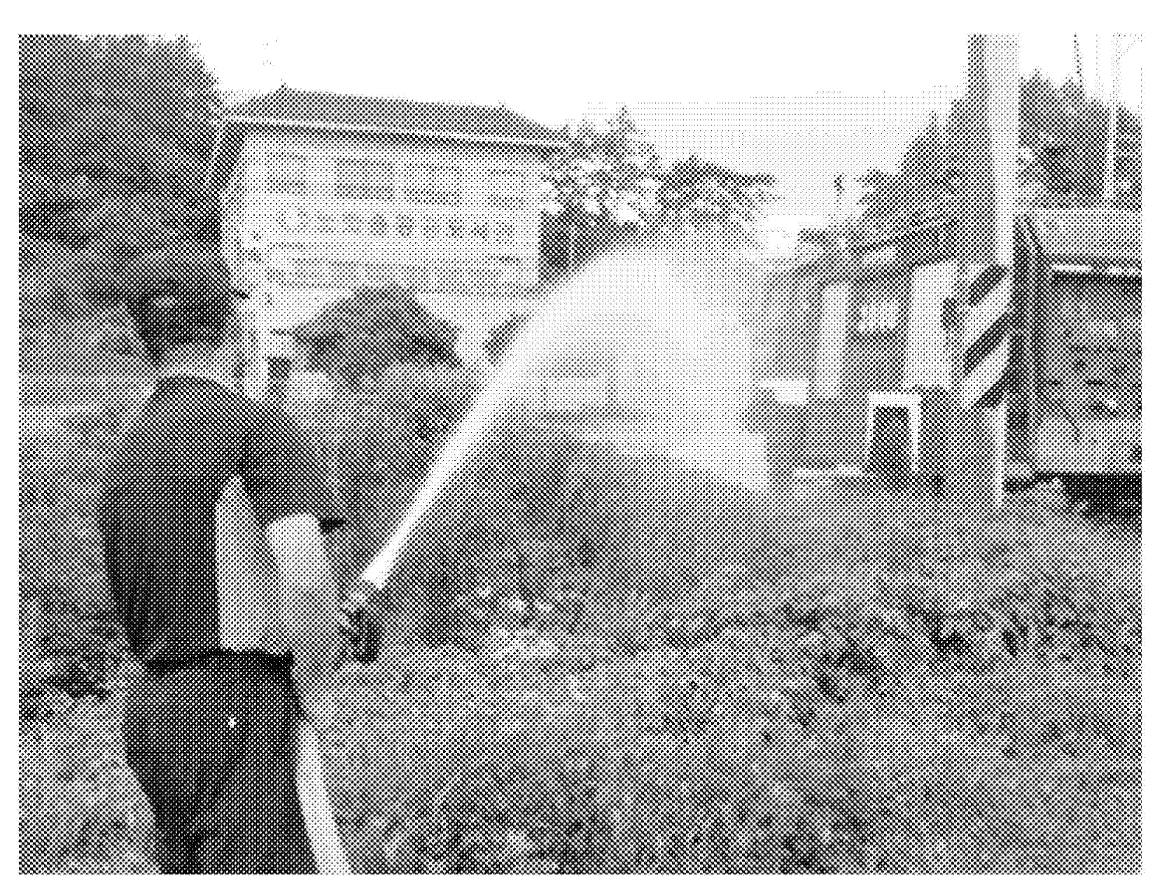

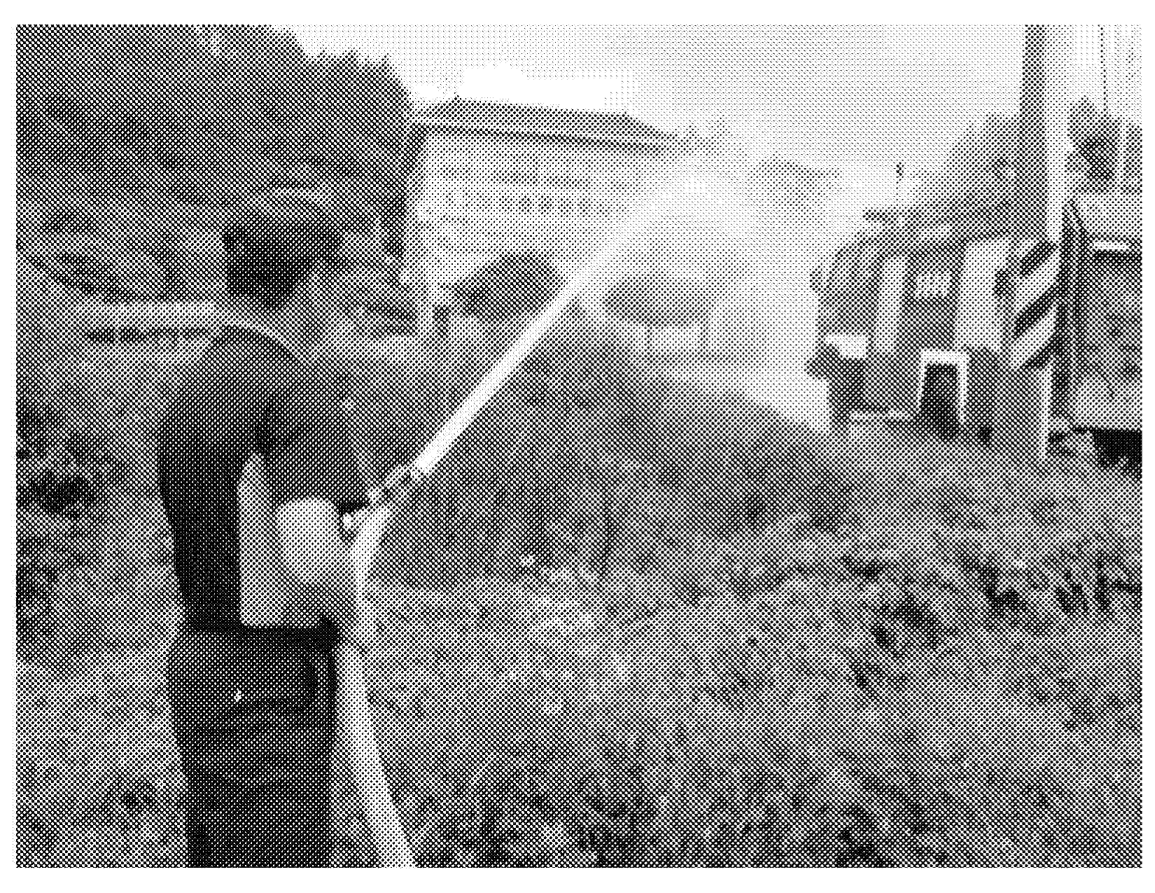

FIG. 5 is a photograph illustrating a state in which fluid is ejected by the fire fighting nozzle to which the conventional fluid ejection device is applied, and FIG. 6 is a photograph illustrating a state in which fluid is ejected by the fire fighting nozzle to which the long-distance fluid ejection device according to an embodiment of the present invention is applied.

When comparing FIGS. 5 with 6, it is possible to actually check that the fluid ejection distance of the fighting nozzle to which the long-distance fluid ejection device of the present embodiment of FIG. 6 is applied obviously increases as compared to the fighting nozzle to which the conventional fluid ejection device of FIG. 5 is applied.

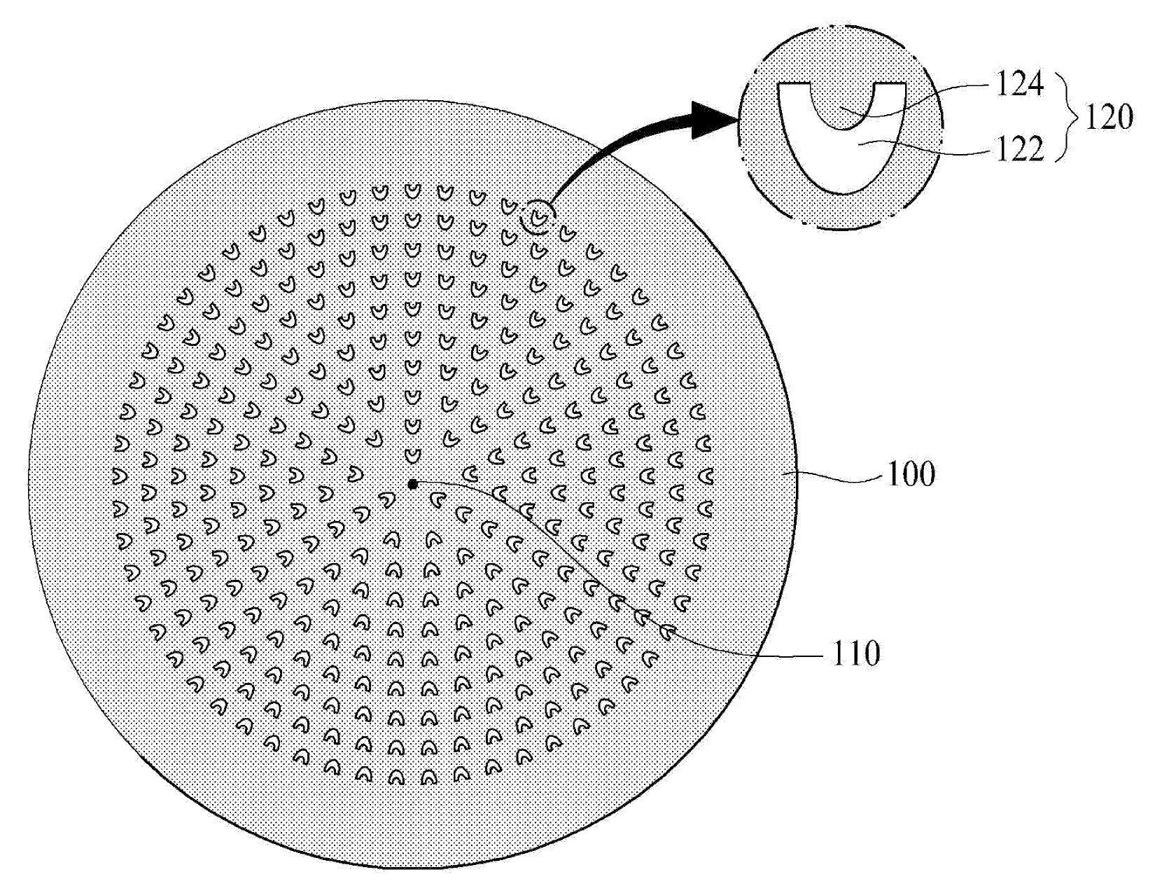

FIG. 7 is a diagram illustrating a nozzle of a long-distance fluid ejection device according to another embodiment of the present invention.

Meanwhile, a long-distance fluid ejection device according to another embodiment of the present invention includes a main body 10, a nozzle 100 and a coupling unit 20.

The present embodiment differs from an embodiment of the present invention in the form of the fluid ejection hole 120, and since the remaining configurations are the same as those of an embodiment of the present invention, the same configurations will not be described.

As illustrated in FIG. 7, the shape of the fluid ejection hole 120 of an embodiment of the present invention has a rounded arrow shape, and meanwhile, the shape of the fluid ejection hole 120 of the present embodiment may be formed in an angular arrow shape or a concave square.

In the present embodiment, the width of the opening 122 of the fluid ejection hole 120 becomes narrower in the direction of the reference point 110, and the direction switching unit 124 may project to the inside of the opening 122 toward the reference point 110.

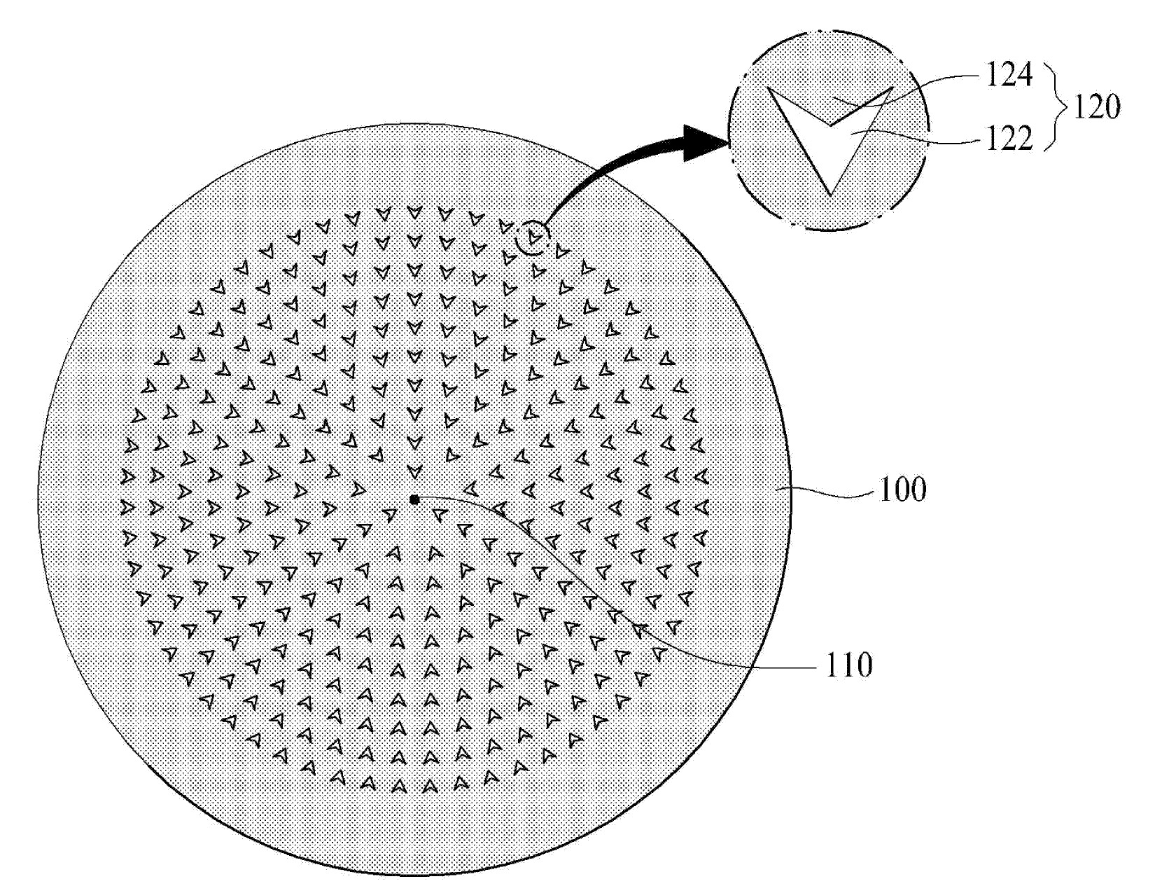

FIG. 8 is a diagram illustrating a nozzle of a long-distance fluid ejection device according to still another embodiment of the present invention.

The long-distance fluid ejection device according to still another embodiment of the present invention may include a main body 10, a nozzle 100 and a coupling unit 20.

The present embodiment differs from the aforementioned embodiments in the form of the fluid ejection hole 120, and since the remaining configurations are the same as those of the aforementioned embodiments, the same configurations will not be described.

As illustrated in FIG. 8, the shape of the fluid ejection hole 120 of this example may be formed in a horseshoe shape in which a semi-circular semi-oval direction switching unit 124 enters the inside of the semicircular or semi-elliptical opening portion 122.

The shape of the fluid ejection hole 120 of an embodiment of the present invention has a rounded arrow shape, and meanwhile, the shape of the fluid ejection hole 120 of the present embodiment may be formed in an angular arrow shape or a concave square.

Also in this embodiment, the width of the opening 122 of the fluid ejection hole 120 becomes narrower in the direction of the reference point 110, and the direction switching unit 124 may enter the opening 122 towards the reference point 110.

Although the preferred embodiments according to the present invention have been described above, it is apparent to those having an ordinary skill in the art that the present invention can be embodied in other specific forms in addition to the previously described embodiments, without departing from its spirit and category. Accordingly, the aforementioned embodiments described above should be considered as being illustrative rather than being restrictive. Accordingly, the present invention may be varied within the category of the appended claims and their equivalent scopes without being limited to the foregoing description.

While the present invention has been described with respect to the specific embodiments, it will be apparent to those skilled in the art that various changes and modifications may be made without departing from the spirit and scope of the invention as defined in the following claims.

1. A long-distance fluid ejection device comprising:
a main body which is connected to a hose through which a fluid flow.
a nozzle which has a circular flat plate shape, and is formed with a plurality of fluid ejection holes disposed in a relatively large number as they go away from the center, the nozzle being provided in a leading end of the main body; and
a coupling unit which couples the nozzle to the main body,
wherein each of the plurality of fluid ejection holes has an opening, and a direction switching unit protruding to the inside of the opening in the radial direction of the nozzle.

2. The long-distance fluid ejection device of claim 1, wherein a center hole from which the fluid is discharged in a straight line is formed at the center of the nozzle.

3. The long-distance fluid ejection device of claim 1, wherein the direction switching unit is formed toward the center of the nozzle from the outside of the radius of the nozzle.

4. The long-distance fluid ejection device of claim 1, wherein the opening has a main ejection region located at the center portion, and a pair of auxiliary ejection regions divided by the direction switching unit.

5. The long-distance fluid ejection device of claim 1, wherein the fluid ejection holes are disposed on a plurality of concentric circles formed based on the center.

6. The long-distance fluid ejection device of claim 5, wherein the plurality of fluid ejection holes located on one concentric circle are disposed so as to be spaced apart from each other at predetermined intervals.

7. The long-distance fluid ejection device of claim 5, wherein the plurality of concentric circles is disposed so as to be spaced apart from each other at predetermined intervals.

8. The long-distance fluid ejection device of claim 1, wherein the fluids ejected through the respective fluid ejection holes are ejected so as to be inclined toward the center axis of the nozzle and are joined at the center axis of the nozzle.

9. The long-distance fluid ejection device of claim 4, wherein the flow rate of the fluid ejected through the fluid ejection hole is concentrated in the direction of the main ejection region by the direction switching unit, and the direction of the fluid ejected through the fluid ejection hole is changed accordingly.
